(19) United States
(12) Patent Application Publication
(10) Pub. No.: US 2018/0121952 A1
(43) Pub. Date: May 3, 2018

(54) Labeling Content

(71) Applicant: Nancy Kwok, Los Angeles, CA (US)

(72) Inventor: Nancy Kwok, Los Angeles, CA (US)

(73) Assignee: GOOGLE INC., Mountain View, CA (US)

(21) Appl. No.: 13/194,112

(22) Filed: Jul. 29, 2011

(51) Int. Cl. G06Q 30/02

(52) U.S. Cl. CPC G06Q 30/0244

(57) ABSTRACT

Methods, systems, and apparatus, including computer programs encoded on a computer storage medium, for labeling and selecting content. In one aspect, a method includes obtaining a set of labels for a multimedia program. The multimedia program includes program portions and one or more advertising portions. Each label in the set specifies a topic to which at least one of the program portions has been identified as relevant. A request for sponsored content is received. The request can be for an upcoming advertising portion, and the request can specify a program portion that is presented temporally adjacent to the upcoming advertising portion. A label (e.g., from the set of labels) with which the sponsored content will be selected is selected. Using the selected label, sponsored content is selected for presentation at the upcoming advertising portion. In turn, data are provided that specify a location from which the selected sponsored content is available.

### BACKGROUND

This specification relates to data processing. In the past, multimedia content presentations, such as television programs, are formatted to include segments of media content (i.e., the television show) and empty segments in which advertisements, station identifiers, news updates, and other content can be inserted. The selection of the content that is to be presented during the empty segments is generally done by the content provider (e.g., broadcast network, local affiliate, cable provider, satellite provider), and is based on agreements between the content provider and sponsors as to the programs and times of day in which the sponsors wish for their sponsored content to be shown.

### SUMMARY

In general, one innovative aspect of the subject matter described in this specification can be embodied in methods that include the actions of obtaining a set of labels for a multimedia program, the multimedia program including program portions and one or more advertising portions, each label in the set specifying a topic to which at least one of the program portions has been identified as relevant; receiving a request for sponsored content to be provided with an upcoming advertising portion, the request specifying an adjacent program portion, the adjacent program portion being one of the program portions that is presented temporally adjacent to the upcoming advertising portion; selecting a label with which the sponsored content will be selected, the label being selected from the set of labels and being a label that has been identified as being relevant to the adjacent program portion; selecting sponsored content for presentation at the upcoming advertising portion, the sponsored content being selected based on the selected label; and providing data specifying a location from which the selected sponsored content is available. Other embodiments of this aspect include corresponding systems, apparatus, and computer programs, configured to perform the actions of the methods, encoded on computer storage devices.

These and other embodiments can each optionally include one or more of the following features. Obtaining a set of labels can include obtaining a set of labels based on an analysis of audio content or video content of the multimedia content. The adjacent program portions for each of the advertising portions can be specified prior to presentation of the multimedia program. The adjacent program portions for each of the advertising portions can be dynamically selected during presentation of the multimedia program.

Methods can further include the operations of associating each label in the set of labels with a label time index, the label time index being a value indicative of a temporal position, within the multimedia program, of a program portion to which the label was identified as being relevant; and associating each advertising portion in the multimedia program with an advertising time index, the advertising time index being indicative of the temporal position of the advertising portion within the multimedia program, wherein selecting a label comprises selecting a label based on time differentials between the advertising time index of the upcoming advertising portion and the label time indexes.

Selecting the sponsored content can further include the action of determining that the selected sponsored content is not referenced by a restricted content list that identifies sponsored content that are prevented from being presented at the upcoming advertising portion.

Obtaining the set of labels can include the action of selecting the set of labels during presentation of the multimedia content, the set of labels being selected based on analysis of the audio content or the video content that is being presented. Selecting sponsored content can include the action of selecting sponsored content having targeting keywords that match the selected label.

Particular embodiments of the subject matter described in this specification can be implemented so as to realize one or more of the following advantages. Advertisements (or other content) that are relevant to the portions of the program that are presented adjacent to an advertisement break can be selected based on labels that have been selected for the advertisements and the portions of the program that are adjacent to the advertisement slot. The labels for multimedia content can be dynamically selected, for example, as a live program is being presented so that advertisements that are relevant to the portion of the program that are adjacent to the advertisement slot can be selected even if the placement of the advertisement slot is not known prior to presentation of the live program.

Advertisements can be dynamically inserted into broadcast or online multimedia content while the content is being presented. Thus, the advertisements need not be pre-scheduled. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for labeling multimedia content.

FIG. 2 is a block diagram of an example multimedia content item.

FIG. 3 illustrates an example timeline for a multimedia content item.

FIG. 4 is a flow diagram of an example process for labeling multimedia content.

FIG. 5 is a schematic diagram of an example of a generic computer system.

Like reference numbers and designations in the various drawings indicate like elements.

### DETAILED DESCRIPTION

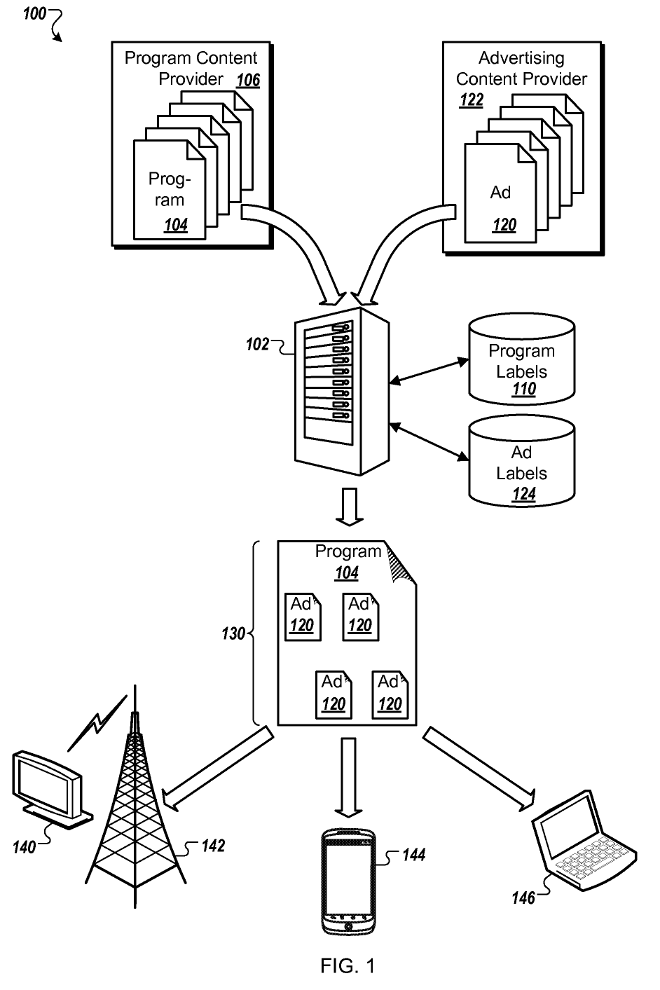

FIG. 1 is a block diagram of an example system 100 for labeling multimedia content. In general, a data processing apparatus such as a content server 102 analyzes multimedia content (e.g., television programming, radio programming, streaming media) and sponsored content (e.g., advertisements, commercials) to determine collections of labels that are descriptive of each. The labels can be used individually, or can be used in combination to determine topics or contexts that describe the multimedia content and sponsored content. By determining one or more labels within segments of a program that are time-wise close to commercial slots, the content server 102 can determine one or more commercials that may be contextually related to the segments of programming prior to or following the commercial presentation. In some implementations, by identifying and presenting commercials that are relevant to the topics raised in program segments appearing before or after the commercial, the effectiveness of the presented commercial may be increased.

In the illustrated example, the content server 102 receives one or more multimedia content programs 104 that are provided by a multimedia program content provider 106. In some implementations, the multimedia content programs 104 can be live or pre-recorded television programs, streaming video content, movies, radio programming, streaming audio, or any other appropriate media content. The content server 102 analyzes the programs 104 to determine labels that are associated with the content of the programs 104. For example, the content server 102 may analyze closed captioning or other subtitles associated with the programs 104 to extract keywords, topics, or contextual information that is descriptive of the programs 104. In another example, the content server 102 may perform image processing on the programs 104 to identify faces, product logos, displayed text, or actions performed during various segments of the programs 104 to determine one or more labels that are descriptive of the identified items or actions. In yet another example, the content server 102 may perform audio processing of the programming to transcribe spoken dialog, to identify music, or to identify other sounds included in the programs 104.

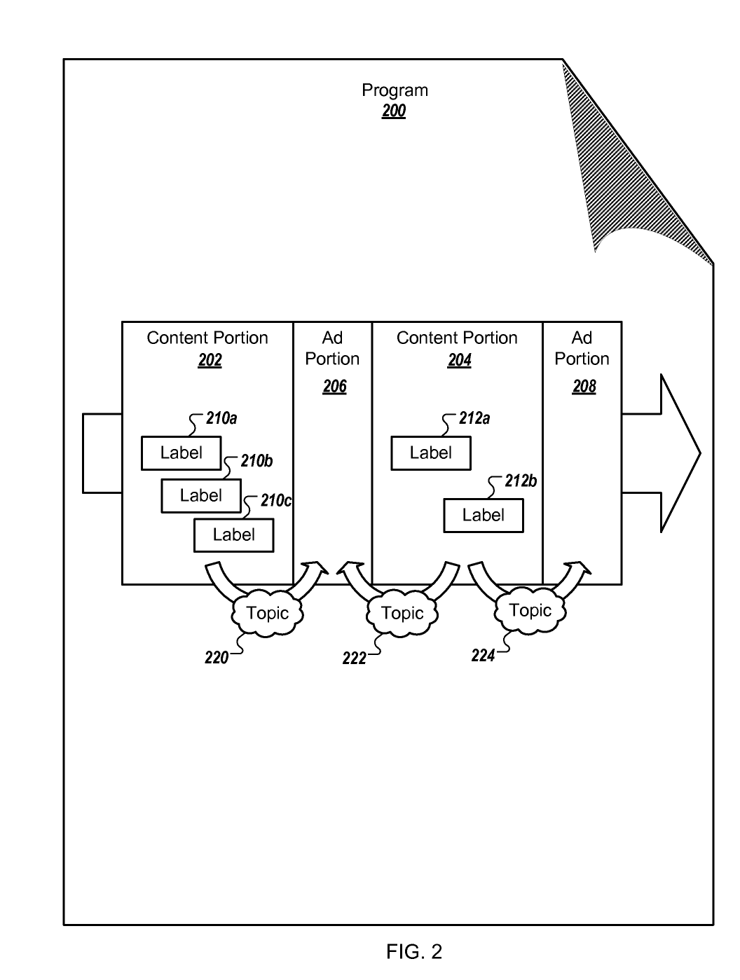

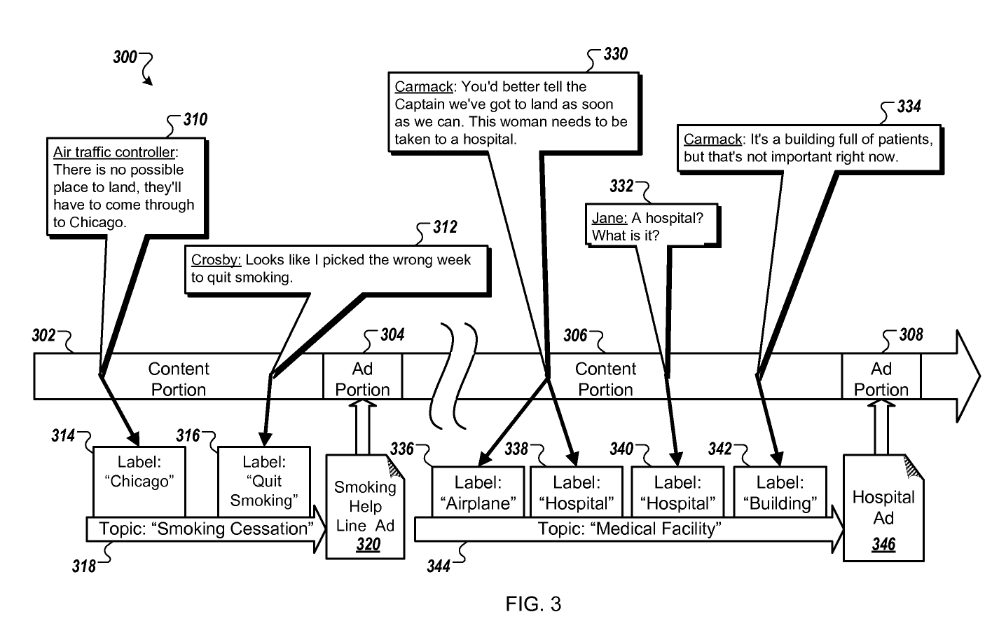

The content server 102 stores the labels drawn from the programs 104 in a data store 110. In some implementations, the data store 110 can be a database file, a list, a collection of one or more text or binary files, or any other appropriate format in which the label information can be stored. As will be discussed in the descriptions of FIGS. 2 and 3, the programs 104 include content portions and advertisement portions. In some implementations, the content server 102 can also store in the data store 110 an identifier for the program 104 from which the label was drawn, and/or as an identifier for the content portion or timestamp within the program 104 from which the label was drawn, in association with the label.

The content server 102 also receives one or more advertisements 120 from an advertising content provider 122. In some implementations, the advertisements 120 can be live or pre-recorded promotional spots, streaming video content, streaming audio, or any other appropriate media content. The content server 102 analyzes the advertisements 120 to determine labels that are associated with the content of the advertisements 120. For example, textual content (e.g., subtitles, captions), images, and audio may be processed to determine keywords, brand names, topics, or contexts that are descriptive of the advertisements 120 or the products they promote. In some implementations, the keywords that are associated with particular advertisements 120 may be provided by the advertising content provider 122. The content server 102 stores the labels drawn from the advertisements 120 in a data store 124.

A combined program 130 includes the program 104 and the advertisements 120 that have been identified by the content server 102 for presentation in association with the program 104. As will be discussed further in the descriptions of FIGS. 2 and 3, each program 104 includes multimedia content portions (e.g., the television program itself) and sponsored content portions (e.g., commercial slots). The content server 102 identifies advertisements 120 for placement in the various sponsored content portions based on the labels associated with the advertisements and the labels associated with the program 104.

More specifically, the content server 102 identifies advertisements 120 to be presented during a sponsored content portion based on labels derived from content portions substantially adjacent to the sponsored content portion. In some implementations, the effectiveness of the advertisements 120 may be increased by presenting the advertisements 120 during commercial slots that follow of proceed a topically relevant scene or event in the program 104. For example, the program 104 may show two lost hikers walking through the desert before fading to a commercial for lemonade or bottled water. In another example, a commercial for run-flat tires may be shown immediately before a scene in which the hero's car suffers a flat tire.

The combined program 130 is then provided to viewers through distribution media such as a television 140 receiving programming from an affiliate 142 (e.g., broadcast station, cable television provider, satellite provider), through a mobile device 144 (e.g., a smartphone) receiving streaming content from a cellular network provider, or through a computer 146 receiving content from a streaming media website. In some implementations, other devices may be used to receive the combined program 130. For example, the combined program 130 can be an audio program received by a radio or streaming digital audio device.

In some implementations, the combined program 130 may be a video game or other form of interactive media, and the content server 102 may form the combined program 104 by inserting the advertisements 120 into the game based on events that happen within the game. For example, after a player wins the season in a sports game, the simulated players may drench the simulated coach in an identified brand of sports drink.

FIG. 2 is a block diagram of an example program 200. The program 200 is a multimedia content item, such as a television program, a radio program, a streaming media program, or any other appropriate form of media presentation. In some implementations, the program 200 can be the program 104 or the combined program 130 of FIG. 1.

The program 200 includes a content portion 202 and a content portion 204. The content portions 202, 204 represent the portions of the program 200 that include programming content (e.g., the show itself, the non-advertisement portions of the presentation). The program 200 also includes an advertisement portion 206 and an advertisement portion 208. The advertisement portions 206, 208 are sponsored content portions that represent portions of the program 200 that have been designated for advertisements or other content (e.g., commercials, station identifiers, public service announcements). While in the illustrated example, the program 200 is shown has including two content portions and two advertisement portions, in some embodiments the program 200 can include any number of content portions and advertisement portions in any order or combination.

The content portions 202, 204 represent subsections of the program 200, such as scenes from a show, segments of a newscast, or plays of a sports event. The content portion 202 is analyzed (e.g., by the content server 102) to determine a collection of labels 210a-210c. In some implementations, the labels 210a-210c may be determined by extracting subtitles or closed caption text associated with the content portion 202 to determine keywords, topics, or contexts that describe the content portion 202. For example, closed caption text can include a transcription of a character saying “all the rooms in the hotel are booked already”, and this text may be processed to determine labels such as “hotel”, “room”, and “book”. In another example, closed caption text can include descriptions of audible content in the content portion 202, such as “burglar alarm sounding”, and this description may be processed to determine labels such as “alarm” and “burglar”.

In some implementations, the labels 210a-210c may be determined by performing speech recognition or other audio recognition operations on audio included in the content portion 202 to determine keywords, topics, or contexts that describe the content portion 202. For example, music in the background of the content portion 202 may be identified as Mozart's “The Magic Flute”, and this identification may be processed to determine labels such as “Mozart” and “classical music”.

In some implementations, the labels 210a-210c may be determined by performing image processing on video included in the content portion 202 to determine keywords, topics, or contexts that describe the content portion 202. For example, during a televised skiing championship, a skier may complete a run and then promptly remove her skis to display her sponsor's logo to the camera. This logo may be processed to identify the product (e.g., Ski Model Y) or company associated with it (e.g., Brand X Skis), and this identification may be processed to determine labels such as “skiing”, “Brand X” and “Ski Model Y”.

The content portion 204 includes a collection of labels 212a-212b. In a substantially similar way to how the labels 210a-210c are determined for the content portion 202, the collection of labels 212a-212b is determined from media content included in the content portion 204.

The collection of labels 210a-210c is processed to determine a topic 220 that is descriptive of the collection of labels 210a-210c. For example, the labels 210a-210c may be “stock”, “trade”, and “futures”, and the topic 220 may be determined as being “financial trading”. In another example, the labels 212a-212b may be “car” and “truck”, and the topics 222 and 224 may be “automobiles”.

The topics 220-224 are used individually or in combination to select sponsored content (e.g., the advertisements 120) to be presented during the advertising portions 206 and 208. For example, the topic 224 (e.g., “automobiles”) may be used alone to identify sponsored content (e.g., a car commercial) that is relevant to the labels 212a-212b and/or the topic 224. In another example, the topics 220 and 222 (e.g., “financial trading” and “automobiles”) may be used together to identify sponsored content for presentation during the advertising portion 206, such as a commercial promoting a car company's financial strength (e.g., to encourage stock traders to invest in the company, rather than to promote a particular model of car).

FIG. 3 illustrates an example timeline 300 for a multimedia content item. In general, the timeline 300 is a conceptual representation of the arrangement of advertising portions and content portions of a multimedia program, such as the combined program 130 of FIG. 1 or the program 200 of FIG. 2. The timeline 300 also illustrates the temporal arrangement of example events that occur during content portions and their temporal relations to the advertising portions.

The timeline 300 includes a content portion 302, an advertising portion 304, a content portion 306, and an advertising portion 308. In some implementations, the content portions 302 and 306 may be the content portions 202 and 208 of FIG. 2. In some implementations, the advertising portions 304 and 308 may be the advertising portions 206 and 208. In the illustrated example, the content portion 302 includes a dialog 310 and a dialog 312. The dialogs 310, 312 include information determined from the content portion 302. For example, the dialogs 310, 312 include text (e.g., derived from closed caption text or from text-to-speech processing of an audio track) from a conversation between two characters that occurs during presentation of the content portion 302.

At the dialog 310, among other things, the speaker mentions the word “Chicago”. The word “Chicago” is extracted and is used as a label 314 that is associated with the timeline 300 at substantially the time-wise point at which the word was spoken in the content portion 302. At the dialog 312, the actions and words of the speaker are processed to determine a label 316 of “quit smoking” that is associated with substantially the time-wise point at which the label 316 was derived from the content portion 302.

The labels 314 and 316 are then processed, such as by the content server 102, to determine a topic 318. In some implementations, the temporal proximity of one or more labels to an adjacent advertising portion may be used to determine the topic 318. For example, the label 316 “quit smoking” is temporally closer to the advertising portion 304 than the label 314 “Chicago”, therefore the label 316 may be given greater weight than is given to the label 314 for determining the topic 318 (e.g., “smoking cessation”). The topic 318 is then processed to determine a sponsored content 320 that is to be presented during the advertising portion 304. In the illustrated example, the topic 318 of “smoking cessation” is used to select an advertisement for a smoking help line as the sponsored content 320.

A collection of dialogs 330, 332, and 334 include text from another conversation between two characters that occurs during presentation of the content portion 306. At the dialog 330, among other things, the speaker mentions the word “hospital” in the context of an “airplane”. These terms are used as a label 336 and a label 338. The word “hospital” is determined from the dialog 332, and is used as a label 340 that is associated with the timeline 300 at substantially the time-wise point at which the word was spoken in the content portion 306. At the dialog 334, the actions and words of the speaker are processed to determine a label 342 of “building” that is associated with substantially the time-wise point at which the label 342 was derived from the content portion 306.

The labels 336-342 are processed to determine a topic 344. In some implementations, the frequency with which similar labels appear during a content portion may be used to determine a topic for the content portion. For example, the label “hospital” appears twice, as labels 338 and 340. The label 342 “building”, although temporally more proximal to the ad portion 308 than the labels 338 and 340, may be given less weight than the repeated use of the term “hospital” in the temporally less proximal labels 338 and 340. In some implementations, combinations of labels may be used to determine a topic. For example, the label 340 “hospital” and the label 342 “building” may be combined to determine the topic 344 of “medical facility”. The topic 344 is then used to determine that a sponsored content item 346 is to be presented during the advertising portion 308. In the illustrated example, the topic 344 “medical facility” is used to determine that the sponsored content item 346 is to be an advertisement for a hospital.

In some implementations, the sponsored content items 320 and 346 may be provided as data specifying the locations of the sponsored content items 320, 346. For example, the content server 102 can provide a uniform resource locator (URL), a file path, or other identifier that can indicate locations from which the selected sponsored content items 320, 346 are available. In some implementations, the content server 102 or the affiliate 142 may access the sponsored content items 320, 346 at the indicated locations to insert the sponsored content items 320, 346 into the advertising portions 304, 308. For example, the content server 102 or the affiliate 142 may splice the sponsored content items 320, 346 into the combined program 130 (e.g., a prerecorded show with commercials placed within it). In another example, the content server 102, the affiliate 142, the mobile device 144, or the computer 146 may use the indicated locations to dynamically insert the sponsored content items 320, 346 into a content stream (e.g., dynamically select and insert commercials based on the topics determined during the content portion of an event that is being broadcast live).

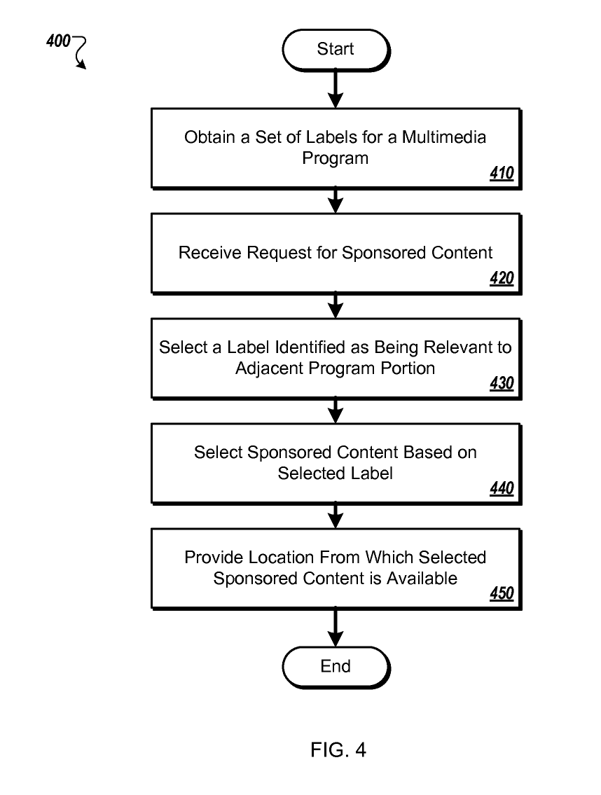

FIG. 4 is a flow diagram of an example process 500 for labeling multimedia content. In some implementations, the process 500 may be performed by the content server 102 of FIG. 1. The process 400 begins by obtaining a set of labels for a multimedia program. The multimedia program includes program portions and one or more advertising portions. Each label in the set specifies a topic to which at least one of the program portions has been identified as relevant. For example, the content server 102 can analyze the program 200 of FIG. 2, which includes the content portions 202 and 204, as well as the advertising portions 206 and 208. The content portions 202, 208 include the labels 210a-210c and 212a-212b that are used to specify the topics 220-224.

In some implementations, obtaining a set of labels can include obtaining a set of labels based on an analysis of audio content or video content of the multimedia content. For example, speech recognition may be performed on the content portion 302 to determine keywords that may be used as the labels 314 and 316. In another example, image or video analysis may be performed to recognize text (e.g., optical character recognition), faces, objects, logos, or any other appropriate visual content that can be recognized and from which labels may be obtained. For example, an actor onscreen may raise a bottle of soda to her lips, and the content server 102 may identify a product logo on the bottle, create a label with the product's name, and then select to present an advertisement for the soda shown in the video.

At step 420, a request for sponsored content to be provided with an upcoming advertising portion is received. The request specifies an adjacent program portion, the adjacent program portion being one of the program portions that are presented temporally adjacent to the upcoming advertising portion. For example, in the timeline 300 of FIG. 3, the occurrence of the advertising portion 304 may trigger a request for sponsored content that is topically related to the temporally adjacent content portions 302 and/or 306.

In some implementations, the adjacent program portions for each of the advertising portions can be specified prior to presentation of the multimedia program. For example, in a pre-recorded television program, “commercial slots” are generally provided for the presentation of sponsored content. As such, commercials are generally planned for in the scripts and production of such programs.

In some implementations, the adjacent program portions for each of the advertising portions can be dynamically selected during presentation of the multimedia program. For example, during a live broadcast of a sporting event, sponsored content may be shown during breaks in play (e.g., during a time out, between innings, during a referee decision). Such breaks, however, may be dependent upon the gameplay and therefore may be difficult to predict.

In some implementations, obtaining the set of labels can include selecting the set of labels during presentation of the multimedia content, the set of labels being selected based on analysis of the audio content or the video content that is being presented. For examples such as these and others, the content server 102 may monitor the content of the programming substantially continuously to determine labels that are descriptive of the presented content. For example, the content server 102 may monitor the content of a live awards show to determine the announced winners' names or to identify marquee logos or film clips that are shown, in order to determine labels for association with them. When a notification is given that an advertising portion is to be presented (e.g., the referee blows a whistle indicating a pause in gameplay), the content server 102 may use recently determined labels to dynamically identify a sponsored content that is to be presented during the advertising portion.

In some implementations, each label in the set of labels can be associated with a label time index, the label time index being a value indicative of a temporal position, within the multimedia program, of a program portion to which the label was identified as being relevant. For example, the label 316 may be associated with a timestamp that indicates that the label 316 was determined from the content portion 302 at a point along the timeline 300 at which the dialog 312 was spoken. In some implementations, each advertising portion in the multimedia program can be associated with an advertising time index, the advertising time index being indicative of the temporal position of the advertising portion within the multimedia program. For example, the advertising portion 304 can be associated with a timestamp that indicates the position of the advertising portion 304 along the timeline 300. In some implementations, the selection of a label can include selecting a label based on time differentials between the advertising time index of the upcoming advertising portion and the label time indexes. For example, the label 316 may be selected due to its temporal proximity to the advertising portion 304 along the timeline 300. As such, the label 316 may be used to determine that the sponsored content item 320 is to be presented at the advertising portion 304.

At step 430 a label is selected, with which the sponsored content will be selected. The label is selected from the set of labels and is a label that has been identified as being relevant to the adjacent program portion. For example, the label 316 is selected from the labels 314-316 in the content portion 302 that is temporally adjacent to the advertising portion 304.

At step 440, sponsored content is selected for presentation at the upcoming advertising portion, and the sponsored content is selected based on the selected label. For example, the label 316 “quit smoking” is selected, and a smoking help line advertisement is selected as the sponsored content item 320 that is to be presented at the advertising portion 304.

In some implementations, selecting sponsored content can include selecting sponsored content having targeting keywords that match the selected label. For example, a commercial for a “hybrid car” may be presented following program content that is given the label “hybrid car”. In some implementations, sponsored content may be selected by selecting sponsored content having targeting keywords that relate to the selected label. For example, the commercial for the “hybrid car” may be selected for presentation following program content that is given labels such as “gasoline”, “predict”, and “higher prices”. In some implementations, the match between the label and the targeting keywords need not be exact. For example, the match may be determined by a minimum relevance score (e.g., cosine similarity measure), a synonym, word expansion, a stub, a plural, or by any other appropriate method that may be used to determine the correspondence between determined labels and available sponsored content.

The sponsored content that is selected in response to a detection of a particular label can vary based on characteristics of the program content with which the sponsored content is to be provided. In some implementations, the sponsored content that is eligible to be provided with a particular program can be based, at least in part, on the audience rating that has been assigned to the program content. For example, as described in more detail below, the entity that operates the content server 102 of FIG. 1 may specify a general set of eligibility rules that specify types of sponsored content that are ineligible to be selected for presentation with program content having particular audience ratings, while advertising content providers and/or program content providers can further specify content-specific sets of eligibility rules that further limit the advertisements that are eligible to be provided with content programs based on the audience ratings (or other program content information).

An audience rating for program content is data specifying a group of viewers for which the program has been deemed appropriate and/or content labels that specify types of content that may be objectionable to audience members. For example, program content that has been assigned an audience rating of “G” may indicate that the program content is appropriate to be viewed by all viewers, while program content that has been assigned an audience rating of “MA” may indicate that the program is only appropriate for mature viewers (e.g., viewers that are at least 17 years old). Program content that is assigned a content label of “V” may indicate that the program content includes violence, while program content that is assigned a content label of “L” may indicate that the program content includes crude language.

In some implementations, the general set of eligibility rules that are specified, for example, by the entity that operates the content server 102 of FIG. 1, can specify one or more categories of sponsored content that are ineligible to be presented with program content that have been assigned a particular audience rating (or content label). For example, the general set of eligibility rules can specify that sponsored content promoting violent movies are not eligible to be selected for presentation with program content that has been assigned an audience rating of “G.” In this example, when sponsored content is being selected for presentation with program content that has been assigned an audience rating of “G” the content server 102 will not select any sponsored content that have been identified as promoting violent movies (e.g., based on the labels that are associated with the sponsored content). The general set of eligibility rules can further specify that sponsored content that includes sexually suggestive content also be ineligible for presentation with the program content that has been assigned an audience rating of “G”.

Advertising content providers and/or program content providers can create content-specific eligibility rules that further restrict the types of sponsored content that are eligible for presentation with program content that has been assigned a particular audience rating (or content label). For example, a program content provider may wish to prevent sponsored content promoting a controversial medical treatment from being presented with a particular program. In this example, the content server 102 may receive from the program content provider a phrase (e.g., one or more terms) that describes the controversial medical procedure, and create a content-specific eligibility rule for the program content. The content-specific eligibility rule can indicate that sponsored content having labels that match the phrase are ineligible for presentation with the program content for which the content-specific eligibility rule was created.

Advertising content providers can similarly create content-specific eligibility rules that restrict program content (or proper subsets thereof) with which particular sponsored content is ineligible for presentation. For example, an advertising content provider can specify that particular sponsored content is ineligible to be presented with program content that has been assigned an audience rating of “G”. Additionally, the advertising content provider can specify a phrase (e.g., one or more words) that describes program content with which the advertising content provider does not want the particular sponsored content presented. The content server 102 can receive this phrase and create a content-specific eligibility rule that prevents the sponsored content from being selected for presentation with program content that has a label matching the phrase.

Content-specific eligibility rules (for program content or sponsored content) can be specified on a per-program basis or a per-content portion basis. For example, an advertising content provider can specify that their sponsored content not be eligible for presentation with any portion of a program that has a label matching the phrase that is included in the content-specific eligibility rule for the sponsored content. Alternatively, or additionally, the advertising content provider can specify that their sponsored content not be eligible for presentation in an ad portion immediately following (or within a threshold period following) a content portion having a label that matches the phrase in the content-specific eligibility rule. For example, an auto manufacturer may not want advertisements for their car to be eligible for presentation in an ad portion that immediately follows a content portion in which a car crashes due to faulty brakes. However, they may be willing for their advertisement to be presented in ad portions that following subsequent content portions of the same program.

In some implementations, selecting the sponsored content further includes determining that the selected sponsored content is not ineligible to be presented at the upcoming advertising portion. For example, the program 200 may be a children's program, and the content server 102 may reference a one or more eligibility rules for the program 200 (e.g., beer commercials, R-rated movie trailers). As described above, a sponsor may identify particular programs or content with which they do not wish the sponsored content to be associated. Examples may include a religious organization that does not wish to have its message perceived as supporting a risqué morning radio show, or an athletic wear company that does not wish for their product to be associated with a disgraced professional athlete.

At step 450, data specifying a location from which the selected sponsored content is available is provided. For example, a URL or file path to the location of the sponsored content item 320 may be provided to the affiliate 142. The affiliate 142 may then access the sponsored content item 320 at the URL or file path in order to access the sponsored content item 320 for presentation during the advertising portion 304 (e.g., to show the diet plan ad during the commercial slot).

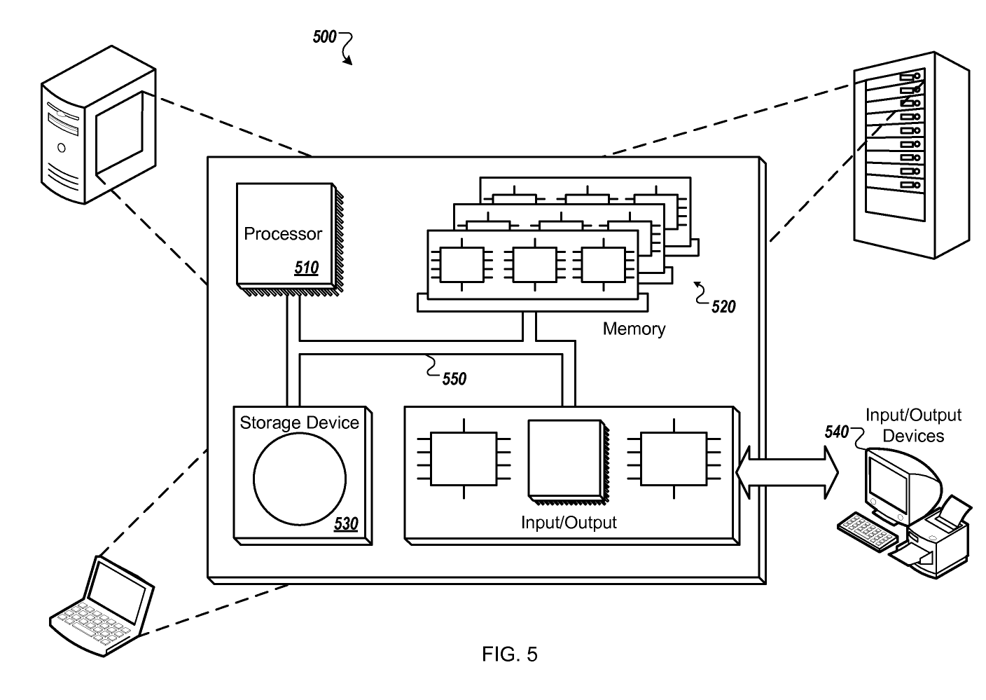

FIG. 5 is a schematic diagram of an example of a generic computer system 500. The system 500 can be used for the operations described in association with the method 300 according to one implementation. For example, the system 500 may be included in either or all of the content server 102, the mobile device 144, the computer 146, or a computer system utilized by the affiliate 142.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by a data processing apparatus for selecting sponsored content for presentation in advertising portions of multimedia programs that include one or more of audio content or video content, the multimedia programs including program portions and the advertising portions, the method comprising:
receiving, by the data processing apparatus and from a multimedia content provider, a multimedia program comprising audio content or video content and a plurality of program portions and a plurality of advertising portions at different locations within the audio content or video content; and
for a given program portion that is preceded by a prior advertising portion and is adjacently followed by a subsequent advertising portion:
determining, by the data processing apparatus, a set of labels comprising one or more labels for the given program portion of the multimedia program, including determining that the given program portion includes a first label and a second label, the set of labels being determined based on analysis of at least an audio content or a video content that is being presented in the given program portion;
assigning, to each label, a label time index indicative of a temporal position within the given program portion relative to the subsequent advertising portion;
assigning weights to each label based on the label time indexes assigned to the labels, including:
assigning, to the first label, a first weight that is higher than a second weight that is assigned to the second label based on the first label having a first label time index that is closer in temporal proximity to the subsequent advertising portion than a second label time index of the second label, and
increasing weights of labels in proportion to a frequency with which the labels occurs during the given program portion;
determining, by the data processing apparatus, a topic that is descriptive of the given program portion based on the set of labels, including selecting, as the topic that is descriptive of the given program portion, a given topic corresponding to the label having a highest weight;
receiving, by the data processing apparatus and from a user device, a request for sponsored content to be provided in the subsequent advertising portion by the user device;
selecting, by the data processing apparatus, sponsored content based on the topic that is descriptive of the given program portion; and
providing, by the data processing apparatus and to the user device, data specifying a location from which the selected sponsored content is available for presentation in the subsequent advertising portion by the user device,
wherein the user device is configured to interact with a remote server to retrieve the selected sponsored content from the specified location based on the location, and present the selected sponsored content upon occurrence of the subsequent advertising portion.

2. The method of claim 1, wherein determining the set of labels comprises analyzing audio content or video content of the program portions.

3. The method of claim 1, wherein the given program portion for each of the advertising portions are specified prior to presentation of the multimedia program.

4. The method of claim 1, wherein the given program portion for each of the advertising portions are dynamically selected during presentation of the multimedia program.

5. The method of claim 1, further comprising:
associating each advertising portion in the multimedia program with an advertising time index, the advertising time index being indicative of the temporal position of an advertising portion within the multimedia program.

6. The method of claim 1, wherein selecting the sponsored content further comprises determining that the selected sponsored content is not referenced by a restricted content list that identifies sponsored content that are prevented from being presented at the subsequent advertising portion.

7. The method of claim 1, wherein determining the set of labels is based on analysis of audio content or video content of the given program portion being presented.

8. The method of claim 1, wherein selecting sponsored content comprises selecting sponsored content having targeting keywords that match the determined topic.

9. A non-transitory computer storage medium encoded with a computer program, the program comprising instructions that when executed by data processing apparatus cause the data processing apparatus to perform operations comprising:
receiving, by the data processing apparatus and from a multimedia content provider, a multimedia program comprising audio content or video content and a plurality of program portions and a plurality of advertising portions at different locations within the audio content or video content; and
for a given program portion that is preceded by a prior advertising portion and is adjacently followed by a subsequent advertising portion:
determining a set of labels comprising one or more labels for the given program portion by analyzing content the program portions, including determining that the given program portion includes a first label and a second label, the set of labels being determined based on analysis of at least an audio content or a video content that is being presented in the given program portion;
assigning, to each label a label time index indicative of a temporal position within the given program portion relative to a subsequent advertising portion;
assigning weights to each label based on the label time indexes assigned to the labels, including:
assigning, to the first label, a first weight that is higher than a second weight that is assigned to the second label based on the first label having a first label time index that is closer in temporal proximity to the subsequent advertising portion than a second label time index of the second label, and
increasing weights of labels in proportion to a frequency with which the label occurs during the program portion;
determining, by the data processing apparatus, a topic that is descriptive of the given program portion based on the set of labels, including selecting, as the topic that is descriptive of the given program portion, a given topic corresponding to the label having a highest weight;
receiving a request from a user device for sponsored content to be provided in the subsequent advertising portion by the user device;
identifying, by the data processing apparatus, the topic that is descriptive of the given program portion;
selecting sponsored content based on the determined topic; and
providing, to the user device, data specifying a location from which the selected sponsored content is available for presentation in the subsequent advertising portion by the user device,
wherein the user device is configured to interact with a remote server to retrieve the selected sponsored content from the specified location based on the location, and present the selected sponsored content upon occurrence of the subsequent advertising portion.

10. The computer program of claim 9, wherein to determine the set of labels, the data processing apparatus analyzes audio content or video content of the program portions.

11. The computer program of claim 9, wherein the given program portion for each of the advertising portions are specified prior to presentation of the multimedia program.

12. The computer program of claim 9, wherein the given program portion for each of the advertising portions are dynamically selected during presentation of the multimedia program.

13. The computer program of claim 9, further comprising:
associating each advertising portion in the multimedia program with an advertising time index, the advertising time index being indicative of the temporal position of the advertising portion within the multimedia program.

14. The computer program of claim 9, wherein selecting the sponsored content further comprises determining that the selected sponsored content is not referenced by a restricted content list that identifies sponsored content that are prevented from being presented at the subsequent advertising portion.

15. The computer program of claim 9, wherein determining the is based on analysis of audio content or video content of the given program portion being presented.

16. The computer program of claim 9, wherein selecting sponsored content comprises selecting sponsored content having targeting keywords that match the determined topic.

17. A system comprising:
a user device; and
one or more computers operable to interact with the device and to:
identify a multimedia program presented at the user device, the multimedia program comprising audio content or video content and a plurality of program portions and a plurality of advertising portions at different locations within the audio content or video content, a given program portion being proceeded by a prior advertising portion and being adjacently followed by a subsequent advertising portion;
determine a set of labels comprising one or more labels for the given program portion, including determining that the given program portion includes a first and second label, the set of labels being determined based on analysis of at least an audio content or a video content that is being presented in the given program portion;
assign, to each label a label time index indicative of a temporal position within the given program portion relative to the subsequent advertising portion;
assign weights to each label based on the label time indexes assigned to the labels, including:
assign, to the first label, a first weight that is higher than a second weight that is assigned to the second label based on the first label having a first label time index that is closer in temporal proximity to the subsequent advertising portion than a second label time index of a second time label, and
increasing weights of labels in proportion to a frequency with which the label occurs during the given program portion;
determine a topic that is descriptive of the given program portion based on the set of labels, including selecting, as the topic that is descriptive of the given program portion, a given topic corresponding to the label having a highest weight;
receive, from the user device, a request for sponsored content to be provided in the subsequent advertising portion by the user device;
identify the topic that is descriptive of the given program portion;
select sponsored content based on the identified topic; and
provide, to the user device, data specifying a location from which the given sponsored content is available for presentation in the subsequent advertising portion by the user device,
wherein the user device is configured to interact with a remote server to retrieve the selected sponsored content from the specified location based on the location, and present the selected sponsored content upon occurrence of the subsequent advertising portion.

18. The system of claim 17, wherein determining the set of labels comprises analyzing audio content or video content of the program portions.

19. The system of claim 17, wherein the given program portion for each of the advertising portions are specified prior to presentation of the multimedia program.

20. The system of claim 17, wherein the given program portion for each of the advertising portions are dynamically selected during presentation of the multimedia program.

21. The system of claim 17, the one or more computers being further operable to:
associate each advertising portion in the multimedia program with an advertising time index, the advertising time index being indicative of the temporal position of an advertising portion within the multimedia program.

22. The system of claim 17, wherein selecting the sponsored content further comprises determining that the selected sponsored content is not referenced by a restricted content list that identifies sponsored content that are prevented from being presented at the subsequent advertising portion.

23. The system of claim 17, wherein determining the set of labels is based on analysis of audio content or video content of the selected program portion being presented.

24. The system of claim 17, wherein selecting sponsored content comprises selecting sponsored content having targeting keywords that match the determined topic.

25. The method of claim 1, wherein determining a topic further comprises:
assigning still higher weight to a third label having a higher frequency of occurrence in the given program portion than either the first or the second labels; and
basing the topic determination on the still higher weighted third label.
